(19) United States
(12) Patent Application Publication
(10) Pub. No.: US 2024/0209831 A1
(43) Pub. Date: Jun. 27, 2024

(54) ROTOR FOR A WIND POWER INSTALLATION AND METHOD FOR OPERATING A WIND POWER INSTALLATION

(71) Applicant: LCG Energy Holding BV, Heerlen (NL)

(72) Inventor: Michael Opitz, Heerlen (NL)

(21) Appl. No.: 18/401,456

(22) Filed: Dec. 30, 2023

Related U.S. Application Data
(63) Continuation of application No. PCT/EP2022/067547, filed on Jun. 27, 2022.

(30) Foreign Application Priority Data
Jun. 30, 2021 (EP) 21182852.0

(51) Int. Cl. F03D 3/06; F03D 3/00; F03D 3/02; F03D 3/04

(52) U.S. Cl. CPC F03D 3/062; F03D 3/009; F03D 3/02; F03D 3/0409; F05B 2240/372

(57) ABSTRACT

A rotor for a wind power installation and method for operating a wind power installation are provided. The rotor includes a first and a second blade support and a first set of at least two rotor blades. The rotor blades of the first set have a vane-shaped configuration and extend helically from the first to the second blade support. The rotor includes at least one additional blade support and at least one additional set of at least two rotor blades. The rotor blades of the additional set have a vane-shaped configuration and extend helically from the second to the additional blade support. The arrangement of the rotor blades of the additional set is arranged with an angular offset to the arrangement the rotor blades of the first set.

### CROSS REFERENCE TO RELATED APPLICATIONS

This application is a continuation application of international patent application PCT/EP2022/067547, filed Jun. 27, 2022, designating the United States, and claiming priority to European Patent applications EP 21 182 852.0, filed Jun. 30, 2021, and the entire content of these applications is incorporated herein by reference.

### TECHNICAL FIELD

The disclosure relates to a rotor for a wind power installation and methods for operating a wind power installation.

### BACKGROUND

Wind power installations for power generation are known to the person skilled in the art. Such an installation transforms the (kinetic) energy of the wind into electric power. A wind power installation typically includes a rotor exposed to the wind flow, and a generator coupled to the rotor which transforms the (rotational) movement of the rotor induced by the wind into electric power. This power can then be supplied to a power grid or to an energy storage system.

Wind power installations having a horizontally oriented rotational axis of the rotor such as, e.g., in wind power installations including a so-called buoyancy rotor are known. However, wind power installations having rotors the rotational axis of which is vertically oriented, for example, the so-called Savonius rotor are also known. Such wind power installations can have a compact configuration and can particularly also be mounted on the roofs of buildings to generate power.

On the website “http://www.wind-of-change.org/index.php/technik.html”, accessed on 29 Jun. 2021, a helix wind turbine is described which includes two horizontal lens discs mounted on a vertical rotor axis between which two or more semi-circular curved blades are vertically mounted. It is further described that the wind power installation has a helical structure.

US 2010/219643 A1 describes a wind-powered electric power generator having a vertical axis and including photovoltaic combined heat and power generation.

U.S. Pat. No. 11,149,710 B2 describes a wind turbine rotor.

US 2009/045632 A1 describes a kinetic energy installation, particularly wind power installation, including at least one rotor rotating about an axis and including rotor blades.

### SUMMARY

It is an object of the disclosure to provide a rotor for a wind power installation and methods for operating a wind power installation which render the highest possible power output possible at different wind speeds, respectively, such that the energy generated by the wind power installation is as high as possible.

The object is achieved by a rotor for a wind power installation and a method for operating a rotor as described herein.

The rotor for the wind power installation may have a rotational axis, or a rotational axis may be allocated to the rotor. Typically, the rotational axis is a rotational axis oriented in the vertical direction, the vertical direction being oriented parallel to the gravitational direction. Here, the gravitational direction may be oriented from the top to the bottom. Directional information such as “upper”, “lower”, “above”, “below” may refer to this gravitational direction. In the following, a cross-sectional plane of the rotor will refer to a plane oriented perpendicular to the rotational axis.

The rotor includes a first and a second blade support. A blade support may have a disk- or plate-shaped configuration. A blade support may particularly be configured to be rotationally symmetric with respect to the rotational axis.

The rotor further includes a first set of at least two rotor blades, the rotor blades of the first set having a vane-shaped configuration and extending helically from the first to the second blade support.

According to an aspect of the disclosure, the rotor includes at least one additional blade support and at least one additional set of at least two rotor blades, the rotor blades of the additional set having a vane-shaped configuration and extending helically from the second to the additional blade support. The rotor blades of the first and the additional sets may thus be configured to be helical, or have a helical progression, respectively.

Here, the second blade support may be arranged at a distance from the first blade support along the rotational axis, the first blade support being arranged below the second blade support. Here, the additional blade support may be arranged at a distance from the second blade support along the rotational axis, the second blade support being arranged below the additional blade support. Here, the distances between the different blade supports along the rotational axis may be identical, but also different from each other.

The first blade support may also be referred to as the lower blade support, the second blade support as the central blade support, and the additional blade support as the upper blade support.

The rotor blades of the first set may be attached to the first blade support, particularly to an upper side, and to the second blade support, particularly to a lower side here. The rotor blades of the additional set may be attached to the second blade support, particularly to an upper side, and the additional blade support, particularly to a lower side here.

A radius of a blade support in a cross-sectional plane of the rotor may be larger than a radius of a circle having a minimal diameter in which all rotor blades are disposed. The radius of this circle may be, for example, 500 mm, whereas the radius of the blade support may be, for example, 503 mm.

A rotor blade having a vane-shaped configuration may mean that the rotor blade or a surface of the rotor blade exposed to the incident flow has a curved, particularly an arcuate or oval arc-shaped progression in a cross-sectional plane of the rotor extending through the rotor blade. Particularly, a rotor blade may have a surface exposed to the incident flow which has a concave configuration. A center point angle of such a progression may be up to 180° (inclusively). The length of a chord of the circle or oval of such a progression may be in a range of 500 mm to 600 mm, and particularly be 551 mm. The maximum height of the progression above this chord in the radial direction may be in a range of 200 mm to 250 mm, and particularly may be 224 mm. The vane-shaped configuration renders an incident flow of the wind possible. Particularly, the vane-shaped configuration may be implemented according to known configurations of the rotor blades of a Savonius rotor.

The indication that the rotor blades extend helically between two blade supports may mean that, in various cross-sectional planes of the rotor, a reference point of a rotor blade is located between the blade supports on a helical reference line, i.e., on a line which is particularly wound about a shell of a cylinder at a constant pitch. A reference point in a cross-sectional plane of the rotor may be a geometric center point, a center of gravity of a cross-sectional plane, a center point of the curved progression of the rotor blade or the surface exposed to the incident flow, or another point having a predetermined relative in position with respect to the rotor blade in this cross-sectional plane of the rotor.

According to an aspect of the disclosure, the arrangement of rotor blades of the additional set is further arranged with an angular offset to the arrangement of the rotor blades of the first set. This may mean that no rotor blade of the additional set continues the helical extension or the helical progression of a rotor blade of the first set.

In other words, the mounting portions of the rotor blades of the first set on the first blade support may be arranged with an angular offset to the mounting portions of the rotor blades of the additional set on second blade support in a common coordinate system or in a common plane of projection oriented perpendicular to the rotational axis. Alternatively, however, it is also possible that the mounting portions of the rotor blades of the first set on the second blade support are arranged with an angular offset to the mounting portions of the rotor blades of the additional set on the second blade support. The mounting portion may refer to the portion of a rotor blade connected to the rotor support, i.e., to an end portion. Here, the mounting portion may particularly be located in a plane oriented perpendicular to the rotational axis. However, the angle of this angular offset may be different from the angular offset between the various mounting portions of the rotor blades of the first set on the first blade support or on the second blade support here. The angle of this angular offset may particularly be 360°/n.

An angle between the mounting portions of the rotor blades of different sets may particularly be an angle between a first line and an additional line in a common plane of projection oriented perpendicular to the rotational axis, the first line extending in the mounting portion of a rotor blade of the first set through a reference point of this rotor blade and the rotational axis, the additional line extending in the mounting portion of a rotor blade of the additional set through a particularly equivalent reference point of this rotor blade and the rotational axis. The rotor blade of the additional set may particularly be the rotor blade adjacent to an observed rotor blade of the first set in the mathematically positive or negative rotational direction about the rotational axis. In other words, the additional line may be selected from the set of lines connecting the reference points of the rotor blades of the additional set to the rotational axis in the common plane of projection as the line positioned adjacent to the first line in the circumferential direction in the common plane of projection.

The angle of the angular offset between the arrangement of rotor blades of the additional set and the arrangement of the rotor blades of the first set is typically larger than zero and smaller than 360°/n, n referring to the number of the rotor blades in a set. It is particularly preferred that the angle of the angular offset is 360°/2·n, i.e., 60° per set in the case of three rotary blades.

Simulations and experiments have shown that the offset produces a turbo effect since, as compared to an implementation without an offset, more rotor blades can be simultaneously exposed to the wind flow. The turbo effect results in an increased power output at the same inflow velocity as compared to of an implementation without an offset. Therefore, this advantageously results in a rotor which increases a power output.

In another exemplary embodiment, the first set and/or the additional set include(s) exactly three rotor blades. Experiments and simulations have shown that, in this way, a particularly high power output can be achieved.

In another exemplary embodiment, the at least one blade support and/or the at least one rotor blade is/are made of aluminum or plastic. An implementation of aluminum advantageously results in an extremely stable configuration. In case of an implementation of plastic, a weight of the rotor can advantageously be kept low which is particularly advantageous in case of an installation on the roof of a building. In the case of an implementation of plastic, particularly, an injection molding method may be made use of for the production.

In another exemplary embodiment, a helical reference line of a rotor blade intersects a reference plane oriented perpendicular to a rotational axis of the rotor at an angle from an angle range of 64° (inclusively) to 84° (inclusively), typically at an angle of 74°. Experiments and simulations have shown that, in this way, a particularly high power output can be achieved.

In another exemplary embodiment, the rotor includes a housing, the blade support and the rotor blades being arranged in an inner volume of the housing. The housing therefore forms a housing for a rotatable part of the rotor including the blade supports and the rotor blades. The rotor may therefore include the rotatable part and the housing which is particularly arranged in a stationary manner in this case. The housing may particularly include a housing bottom, a housing roof and side walls having an inner volume. The housing may be made of plastic or aluminum. An implementation of aluminum advantageously results in an extremely stable configuration. In case of an implementation of plastic, a weight of the rotor can advantageously be kept low which is particularly advantageous in case of an installation on the roof of a building. In the case of an implementation of plastic, particularly an injection molding method may be made use of for the production of the housing.

The housing may have or form an air inflow portion or an air inflow opening, particularly in the area of a side wall. The housing may also have or form an air outflow portion or an air outflow opening, particularly in the area of another side wall. In case of an operation as intended, air can flow into the housing, flow against the rotor disposed in the housing and set in into rotation in this way, and then flow out of the housing here.

The entirety of the blade supports, and the rotor blades, may be supported in the housing here, particularly rotatably, further particularly on the housing bottom and/or the housing roof.

The housing advantageously renders a guidance of air possible such that the rotor blades are blown against in an improved manner, and therefore a power output can be further increased.

A rotor for a wind power installation including a housing, the housing being configured according to one of the exemplary embodiments described in this disclosure, may constitute an independent disclosure which is particularly independent of the feature that the arrangement of rotor blades of the additional set is arranged with an angular offset to the arrangement of the rotor blades of the first set. Thus, also a rotor for a wind power installation including a first and a second blade support and at least two rotor blades is described, the rotor blades of the first set having a vane-shaped configuration and extending, particularly helically, from the first to the second blade support. The blade support and the rotor blades form a rotatable part of the rotor. Such a rotor includes a housing for this rotatable part, the blade support and the rotor blades being arranged in an inner volume of the housing. Further, such a rotor, particularly the rotatable part, may include at least one additional blade support and at least one additional set of at least two rotor blades, the rotor blades of the additional set having a vane-shaped configuration and extending, particularly helically, from the second to the additional blade support.

In another exemplary embodiment, the housing forms an air inflow portion, e.g., on a front side, the air inflow portion having a funnel-shaped configuration. The funnel-shaped configuration may mean that the air inflow portion is tapered along the flow direction in a cross-sectional plane of the rotor. Particularly, the air inflow portion may have a trapezoidal configuration or include a trapezoidal portion in the cross-sectional plane of the rotor, whereas the base sides of this portion may be oriented perpendicular to the flow direction.

In this way, a flow against the rotor blades is rendered possible such that these are accelerated at a high acceleration which in turn advantageously increases a power output of a wind power installation including this rotor. Particularly, a high inflow pressure on the rotor blades can be achieved by the funnel-shaped configuration.

In another exemplary embodiment, an opening angle of the air inflow portion is an angle from an angle range of 66° (inclusively) to 86° (inclusively), typically an angle from an angle range of 68.4° (inclusively) to 83.6° (inclusively), particularly preferred, an angle of 76°. Experiments and simulations have shown that, in this way, a particularly high power output can be achieved.

In another exemplary embodiment, an angle between a first side wall and another side wall defining the air inflow portion and oriented perpendicular to a cross-sectional plane of rotation is an angle from an angle range of 66° (inclusively) to 86° (inclusively), typically an angle from an angle range of 68.4° (inclusively) to 83.6° (inclusively), particularly typical an angle of 76°. Experiments and simulations have shown that, in this way, a particularly high power output can be achieved.

In another exemplary embodiment, a first side wall defining the air inflow portion and oriented perpendicular to the cross-sectional plane forms at least a portion of a first leg of a trapezoid or a trapezoidal portion of the air inflow portion in a cross-sectional plane oriented perpendicular to the rotational axis of the rotor and encloses an angle from a range of 70° (inclusively) to 84° (inclusively), typically an angle of 77°, together with a base of this trapezoid, another side wall defining the air inflow portion and oriented perpendicular to the cross-sectional plane forming at least a portion of another leg of the trapezoid and enclosing an angle from a range of 20° (inclusively) to 34° (inclusively), typically an angle of 27°, together with the base of this trapezoid. Experiments and simulations have shown that, in this way, a particularly high power output can be achieved.

In another exemplary embodiment, the housing forms an air outflow portion, particularly on a rear side, the air outflow portion having a funnel-shaped configuration. An opening angle of the air outflow portion may be smaller than or equal to 45° here. The air inflow portion and the air outflow portion may be arranged such that they are offset with respect to a center line perpendicularly intersecting the rotational axis.

In another exemplary embodiment, a percentage of a surface area of the rear side of the housing of the entirety of the surface area of the rear side of the housing and the air outflow area is from 20% (inclusively) to 26% (inclusively) at most, typically it is 23% at most. Particularly in connection with the air inflow portion configured as described, this results in such an internal pressure in the housing that a high inflow pressure on the rotor blades can be built up and maintained. This, in turn, advantageously renders the achievement of a high energy output possible.

In another exemplary embodiment, the first blade support is at least partly arranged in a recess in the housing bottom of the housing. Alternatively or cumulatively, the additional blade support is at least partly arranged in a recess in the area of a housing cover of the housing. This advantageously renders an improved flow against the rotor blades as well as a, with respect to the installation space, more compact configuration of the rotor possible.

In another exemplary embodiment, the first blade support has or forms a recess for accommodating and securing a generator shaft. Alternatively or cumulatively, a housing bottom has or forms a reinforced through opening for accommodating the generator shaft. A reinforced through opening may particularly be an opening surrounded by a reinforced portion of the housing bottom. In a reinforced portion, a thickness of the housing bottom which may be, e.g., a dimension parallel to the rotational axis may be increased as compared to non-reinforced portions of the housing bottom. This advantageously results in a reliable fixation of a shaft of a generator and/or a reliable support of the shaft on the housing.

In another exemplary embodiment, the additional blade support includes or forms a bearing element for the support on an upper part of the housing. The bearing element may particularly be formed or disposed on an upper side of the additional blade support as a protrusion, particularly as a cylindrical protrusion.

Alternatively or cumulatively, the upper part of the housing includes or forms a reinforced through opening for accommodating the bearing element. A reinforced through opening may particularly be an opening surrounded by a reinforced portion of the housing cover. In a reinforced portion, a thickness of the housing cover which may be, e.g., a dimension parallel to the rotational axis may be increased as compared to non-reinforced portions of the housing cover. This advantageously results in a reliable fixation of a shaft of a generator and/or a reliable support of the shaft on the housing.

Further, a wind turbine including a rotor and a generator is described. Here, a shaft of the generator may be connected to the rotor, particularly in a non-rotatable manner. Particularly, the shaft of the generator may be attached to a blade support, typically to the first blade support, particularly on a lower side, or also to the additional blade support, particularly on an upper side. The shaft may be supported in the housing, e.g., in/on the housing bottom, e.g., with an appropriate ball or roller bearing here.

The generator or the housing of the generator may be connected, particularly screwed to the housing of the rotor. Here, the generator may typically be arranged below the rotor, i.e., particularly below the first blade support.

The wind turbine may be used for generating power, this power being usable, for example, for heat production, but also for the electric supply in a building. Particularly, the wind turbine may be used for the power generation for private households. For example, the power may be stored in a storage system, used for heating, e.g., with a heating rod, used for operating a heat pump, used for charging an electric or hybrid vehicle, used for the supply of consumers, particularly household appliances such as, e.g., a washing machine, or supplied into a grid.

The wind turbine further advantageously renders an extremely noise-reduced power generation possible. Further, it is low in maintenance and produces power at any time of the year. It may have a low height of 1.40 m. Further, the wind turbine may be installed on the roof of a building. The wind turbine advantageously renders a CO2-free power generation possible.

The wind turbine may further include an energy storage system connected to the generator and storing electric power generated by it. Power consumers may be connected to the energy storage system and/or the generator through an inverter which may also be part of the wind turbine. A storage capacity of the energy storage system may be, e.g., 5 KW or 10 kW.

Further, a method for operating a rotor according to one of the exemplary embodiments described in this disclosure is provided. Here, a generator is mechanically connected to the rotor, and the rotor is exposed to an airflow.

### BRIEF DESCRIPTION OF THE DRAWINGS

The disclosure will now be described with reference to the drawings wherein:

FIG. 1 shows a schematic side view of a rotor according to an exemplary embodiment of the disclosure,

FIG. 2 shows a schematic front view of a wind turbine including a rotor according to an exemplary embodiment of the disclosure,

FIG. 3 shows a schematic longitudinal cross section through a housing of a wind turbine,

FIG. 4 shows a schematic cross section through a rotor in the area of the arrangement of the rotor blades of the first set in a rotational position of the rotor,

FIG. 5 shows a schematic cross section through a rotor in the area of the arrangement the rotor blades of the additional set in the rotational position of the rotor illustrated in FIG. 4,

FIG. 6 shows a schematic view of a common plane of projection,

FIG. 7 shows a schematic cross section through a housing of the rotor,

FIG. 8 shows a schematic illustration of a support of a first blade support on the housing,

FIG. 9 shows a schematic illustration of a support of an additional blade support on the housing, and

FIG. 10 shows a perspective view of the rotor in the housing according to an exemplary embodiment of the disclosure.

### DESCRIPTION OF EXEMPLARY EMBODIMENTS

In the following, the same reference numerals designate elements having the same or similar technical features.

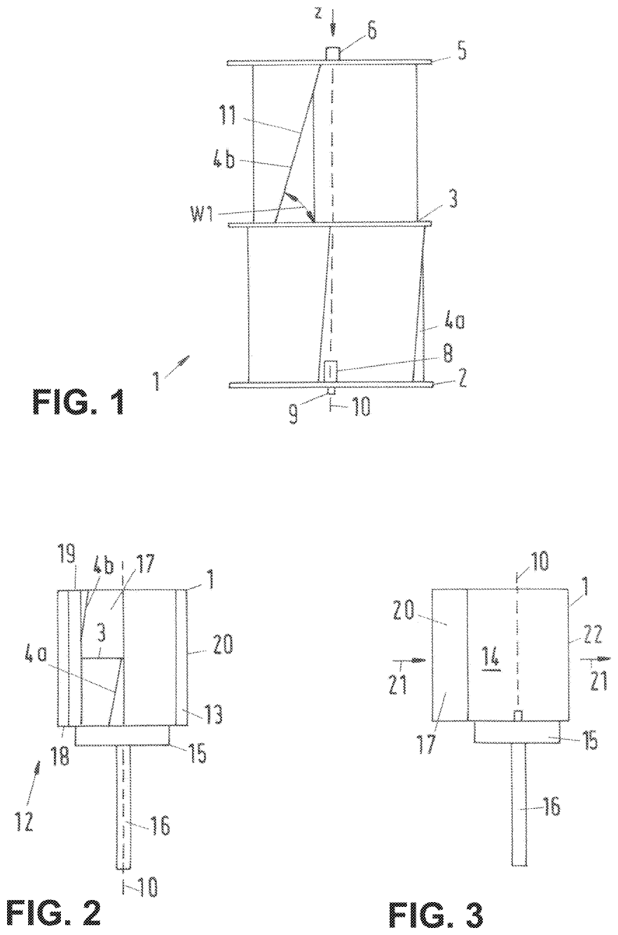

FIG. 1 shows a schematic side view of a rotor 1 according to the disclosure. The rotor 1 includes a first, lower blade support 2, and a second, central blade support 3, and a first set of at least two rotor blades 4a, the rotor blades 4a of the first set having a vane-shaped configuration and extending helically from the first to the second blade support 2, 3.

The rotor 1 further includes an additional (third), upper blade support 5 and an additional set of at least two rotor blades 4b, the rotor blades 4b of the additional set having a vane-shaped configuration and extending helically from the second to the third blade support 3, 5.

The blade supports 2, 3, 5 have a plate-shaped or circular plate-shaped configuration. Further, a bearing member 6 formed as a cylindrical protrusion on an upper side of the third blade support 5 is illustrated. This bearing member 6 serves to support the entirety of the blade supports 2, 3, 5 and the rotor blades 4a, 4b in the housing 13 (see FIG. 2). Further, a bearing member 6 is illustrated which is formed as a cylindrical protrusion on an upper side of the third blade support 5. This bearing member 6 serves to support the entirety of the blade supports 2, 3, 5 and the rotor blades 4a, 4b in the housing 13 (see FIG. 2).

Likewise, it is illustrated that the first blade support 2 has or forms a recess 8 for accommodating and securing a generator shaft 9, this recess 8 being illustrated schematically.

Further, a rotational axis 10 of the rotor 1 and a vertical direction z are illustrated which may be oriented parallel to and in the direction of a gravitational force, particularly in an arrangement of the rotor 1 as intended.

Further, it is illustrated that a helical reference line 11 of a rotor blade 4b intersects a reference plane which is oriented perpendicular to the rotational axis 10 of the rotor 1 at an angle W1 of 74°. In other words, the pitch of the helical or helix-shaped reference line 11 may be 74º.

A distance between the first blade support 2 and the second blade support 3 along the rotational axis 10 (in other words, a height of the arrangement of rotor blades 4a of the first set) may be 700 mm. A distance between the second blade support 3 and the third blade support 5 along the rotational axis 10 (in other words, a height of the arrangement of the rotor blades 4b of the additional set) may also be 700 mm.

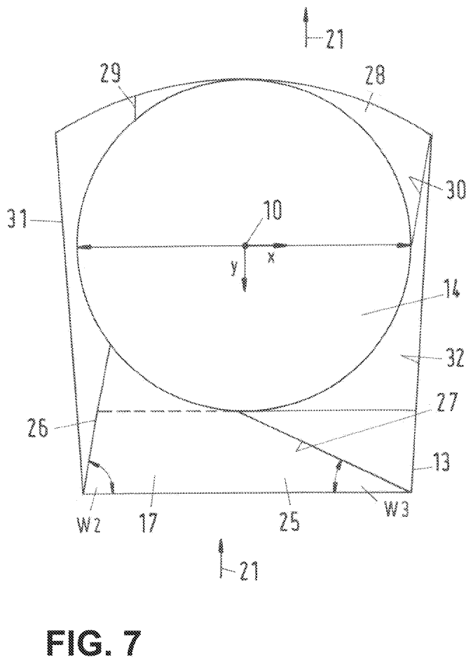

FIG. 2 shows a schematic front view of a wind turbine 12 including a rotor 1 according to an exemplary embodiment of the disclosure. Here, the rotor 1 further includes a housing 13, the entirety of the blade supports 2, 3, 5 and the rotor blades 4a, 4b being arranged in the inner volume 14 (see FIG. 7) of the housing 13. A generator 15 arranged below the housing 13, particularly also below the first blade support 2 is illustrated. The generator 15 is connected to the rotor 1, particularly the first blade support 2, via a shaft 16 in a non-rotatable manner. The shaft 16 may be anchored, particularly anchored in a rotatably supported manner, in a base. The base may be formed, e.g., by a housing roof.

The housing 13 includes a housing bottom 18 and a housing cover 19 and side walls 20 including the inner volume 14. An air inflow portion 17 of the housing 13 is illustrated through which air which is to flow against the rotor blades 4a, 4b flows into the housing 13. The air inflow portion 17 is arranged in the area of a front side of the housing 13 here. The front side may particularly refer to a side exposed to the wind flow in an operation as intended.

FIG. 3 shows a schematic longitudinal cross section through a housing 13 of a wind turbine 12. A flow direction of an air flow through the housing 13 is schematically illustrated by arrows 21. Here, air flows into the housing 13 through an air inflow portion 17, and out of the housing 13 through an air outflow portion 22.

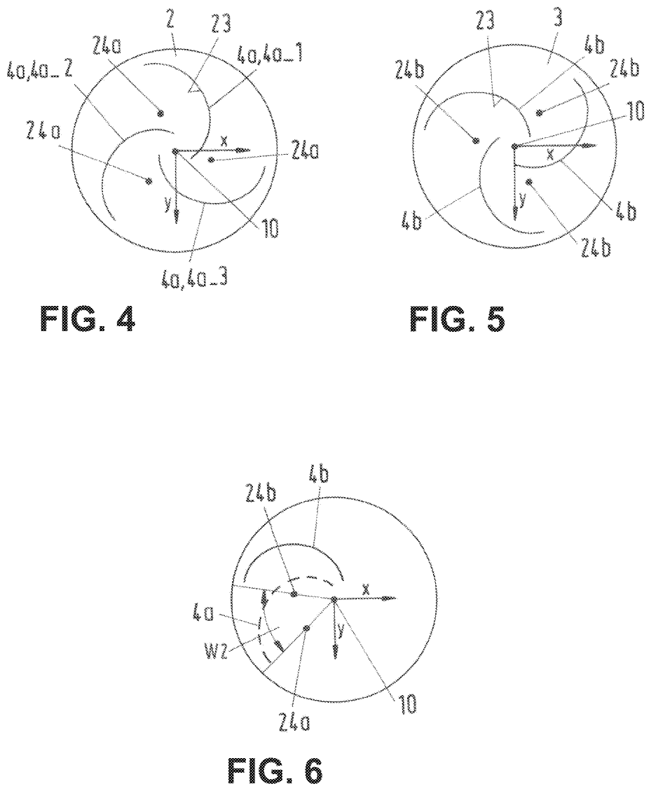

FIG. 4 shows a schematic cross section through a rotor 1 in the area of the arrangement of the rotor blades 4a of the first set in a rotational position of the rotor 1. In the illustrated cross-sectional plane, mounting portions of the rotor blades 4a of the first set are arranged in which these rotor blades 4a are secured on the upper side of the first blade support 2.

A reference coordinate system having a longitudinal axis x and a transverse axis y is illustrated. The longitudinal axis x is oriented perpendicular to the transverse axis y, both axes x, y being oriented perpendicular to the gravitational axis z, respectively. The orientations of the axes x, y are represented by arrows. A center point of the reference coordinate system is located in an intersection point of the rotational axis 10 with the cross-sectional plane.

It is illustrated that the rotor blades 4a have a vane-shaped configuration. In the illustrated exemplary embodiment, the rotor blades 4a or a concavely curved surface 23 exposed to the incident flow formed by these rotor blades 4a have a semicircular progression in the cross-sectional plane. For each of the rotor blades 4a, a center point 24a of this semicircular progression is illustrated here. Lines intersecting these center points 24a and the rotational axis 10 in this cross-sectional plane are arranged with an angular offset relative to each other at an angular offset of 120°, i.e., a line encloses an angle of 120° together with the line a adjoining in the mathematically positive or negative rotational direction about the rotational axis 10.

In the illustrated rotational position, an outer end of a first rotor blade 4a_1 may be located in a second quadrant of the coordinate system and spaced apart from center point or the transverse axis y of the coordinate system at a longitudinal distance of 146 mm along the longitudinal axis x. An inner end of the first rotor blade 4a_1 may be located in a fourth quadrant and, along the longitudinal axis x, spaced apart from the center point or the transverse axis y of the coordinate system at a distance of 77.5 mm and from an inner end of a third rotor blade 4a_3 at a distance of 155 mm. Here, the inner end of the first and the third rotor blade 4a_1, 4a_3 may be located on the same level along the transverse axis.

An inner end of a second rotor blade 4a_2 may be located on the transverse axis y in the area of the transition from the first to the second quadrant and, along the transverse axis y, spaced apart from center point or the longitudinal axis x of the coordinate system at a transverse distance of 103 mm. An outer end of the second rotor blade 4a_2 may be located in the third quadrant and spaced apart from the center point or the longitudinal axis x of the coordinate system at a transverse distance of 345 mm along the transverse axis y. An inner end of a third rotor blade 4a_3 may be located in the third quadrant and spaced apart from the center point or the longitudinal axis x of the coordinate system at a transverse distance of 52 mm along the transverse axis y. An outer end of the third rotor blade 4a_3 may be located in the fourth quadrant and spaced apart from center point or the longitudinal axis x of the coordinate system at a transverse distance of 95 mm along the transverse axis y. Here, the indicated distances are preferred distances. However, it is also possible to arrange the rotor blades at distances deviating therefrom, particularly at distances from a tolerance range having a width of 20% of the indicated distance the central value of which is the indicated distance. Particularly, the distance may therefore be 90% of the indicated distance, or 110% of the indicated distance, or be selected from a range in between.

A radius of the first blade support may be 503 mm here. A minimum radius of a circle enclosing all rotor blades 4a of the first set in the cross-sectional plane may be 500 mm.

FIG. 5 shows a schematic cross section through a rotor 1 in the area of the arrangement the rotor blades 4b of the additional set in the rotational position of the rotor 1 illustrated in FIG. 4. In the illustrated cross-sectional plane, mounting portions of the rotor blades 4b of the additional set are arranged in which these rotor blades 4b are secured on the upper side of the second blade support 3.

The reference coordinate system having the longitudinal axis x and the transverse axis y also illustrated in FIG. 4 is illustrated. Equivalent to the rotor blades 4a of the first set, the rotor blades 4b of the additional set also have a vane-shaped configuration. For each of the rotor blades 4b, a center point 24b of the semicircular progression of the rotor blade 4b or the surface 23 exposed to the incident flow is illustrated here. Lines intersecting these center points 24b and the rotational axis 10 in this cross-sectional plane are arranged with an angular offset with respect to each other at an angular offset von 120°, i.e., a line encloses an angle of 120° together with the adjoining line in the mathematically positive or negative rotational direction about the rotational axis 10.

In the overall view of FIG. 4 and FIG. 5, it can be seen that the arrangement of the rotor blades 4b of the additional set is arranged with an angular offset to the arrangement of the rotor blades 4a of the additional set, particularly with an angular offset of 60°.

FIG. 6 shows a schematic common plane of projection into which the rotor blades 4a, 4b illustrated in FIG. 4 and FIG. 5 were projected, the plane of projection being oriented perpendicular to the rotational axis 10, and only one rotor blade 4a of the first set and one rotor blade 4b of the additional set being illustrated for the sake of clarity. The rotor blade 4a of the first set projected into the common plane of projection is illustrated by a dashed line, and a rotor blade 4b of the additional set is illustrated by a continuous line. In other words, FIG. 6 shows the projection of the rotor blade 4a in the mounting portion of this rotor blade 4a on the first blade support 2 and the projection of the rotor blade 4b in the mounting portion of this rotor blade 4b on the second blade support 3. The rotor blade 4b of the additional set is particularly the rotor blade 4b adjacent to an observed rotor blade 4a of the first set in the negative rotational direction about the rotational axis 10.

It can be seen that the mounting portion of the rotor blade 4a of the first set is arranged on the first blade support 2 with an angular offset to the mounting portion of the rotor blade 4b of the additional set on the second blade support 3 at an angular offset of W2, the angular offset W2 particularly being 60°.

This angle W2 between the mounting portions of the rotor blades 4a, 4b of different sets is the angle W2 between a first line and another line in the common plane of projection, the first line in the mounting portion of the rotor blade 4a of the first set extending through the center point 24a of the semicircular progression of this rotor blade 4a and the rotational axis 10, the other line in the mounting portion of the rotor blade 4b of the additional set extending through the center point of the semicircular progression of this rotor blade 4b and the rotational axis 10.

However, it is also possible that the projection of the rotor blade 4a in the mounting portion of this rotor blade 4a on the second blade support 3 and the projection of the rotor blade 4b in the mounting portion of this rotor blade 4b on the second blade support 3 are arranged with an angular offset with respect to each other at an angular offset of W2, the angular offset W2 particularly being 60°.

FIG. 7 shows a schematic cross section through a housing 13 of the rotor 1, the rotatable part of the rotor 1 including the blade supports 2, 3, 5 and the rotor blades 4a, 4b not being illustrated.

Here, the cross-sectional plane is oriented perpendicular to the rotational axis 10 of the rotatable part of the rotor 1. An inner volume 14 of the housing 13 can be seen which includes an accommodation volume which is circular in the cross section for arranging the rotatable part. A radius of this accommodation volume may be larger than a (maximum) radius of the blade supports 2, 3, 5 and be, for example, 1004 mm here.

Further, an air inflow portion 17 is illustrated which has a funnel-shaped configuration and is tapered along the flow direction 21 of the air. The air inflow portion 17 is particularly formed on the front side of the housing 13. In the illustrated cross section, the air inflow portion 17 includes a trapezoidal portion 25. The trapezoidal portion 25 is particularly a non-isosceles, a non-rectangular, and a non-symmetrical trapezoidal portion.

An angle W2 which is enclosed by a first leg and the base, i.e., the longer base side of the trapezoid is typically 77º, however, it may also be selected from a range of 70° to 84°. An angle W3 which is enclosed by a second leg and the base of the trapezoid is typically 27°, however, it may also be selected from a range of 20° to 34°. In the cross-sectional plane, the first leg of the trapezoid is formed by a first side wall 26 of the housing 13, and the second leg is formed by a second side wall 27 of the housing 13. These side walls 26, 27 define the air inflow portion 17 and are oriented perpendicular to the illustrated cross-sectional plane. Further, the air inflow portion 17 is defined by the housing bottom 18 and the housing cover 19. The angle between the first side wall 26 and the second side wall 27 is typically 76°. However, it may also be selected from a range of 66° to 86°.

The base of the trapezoid may be perpendicular to a predefined or predetermined main flow direction of the wind which is oriented parallel and reverse to a transverse axis y of a reference coordinate system in the illustrated exemplary embodiment.

Further, the housing 13 forms an air outflow portion 28 on a rear side, the air outflow portion 28 having funnel-shaped configuration in the cross-sectional plane and widening along the flow direction 21 of the air. An opening angle of the air outflow portion 28 may be smaller than or equal to 45° here.

Here, the air outflow portion 28 is defined by two side walls 29, 30 and the housing bottom 18 and the housing cover 19 and forms an air outflow area on the outer side. A first side wall 29 is spaced apart from a first outer side wall 31 of the housing at a maximum distance of 291 mm along the longitudinal direction.

A width of the housing 13 on the front side along a longitudinal axis x is 1025 mm, the width of the housing 13 on the rear side is 1249 mm.

The length of the first side wall 26 defining the air inflow portion 17 along the transverse axis y is 300 mm. The length of the second side wall 27 defining the air inflow portion 17 along the transverse axis y is 276 mm. The length of the first outer side wall of the housing 31 and a second outer side wall of the housing 32 along the transverse axis y is 1166 mm. The length of the second side wall 27 defining the air inflow portion 17 along the transverse axis y is 276 mm.

The first outer side wall of the housing 31 and the first side wall 26 defining the air inflow portion 17 intersect in a first front edge of the housing 13. The second outer side wall of the housing 32 and the second side wall 26 defining the air inflow portion 17 intersect in a second front edge of the housing 13. An edge of the first side wall 26 disposed opposite of the first front edge and an edge of the second side wall 27 disposed opposite of the second front edge which define the air inflow portion 17 are spaced apart at a distance of 380 mm from each other along the longitudinal axis x.

The second outer side wall of the housing 32 and the second side wall 30 defining the air outflow portion 18 intersect in a second rear edge of the housing 13. In the cross-sectional plane, a rim of the rear side of the housing 13 has an arcuate progression with a radius which may be, e.g., 500 mm. A percentage of a closed surface area of the rear side of the housing of the entirety of the surface area of the rear side of the housing and the air outflow area of the air outflow portion 28 may typically be 23% at most. This maximum percentage may also be selected from a range of 20% to 26%.

Here, the side walls 26, 27, 29, 30 and the outer side walls 31, 32 of the housing may have a non-curved configuration.

With respect to a plane stretching from a straight line parallel to the main flow direction to the rotational axis 10, the air inflow portion 17 and the air outflow portion 28 are further disposed in different half spaces separated by this plane. For example, this may mean that geometric center points are disposed in these different half spaces. In the illustrated exemplary embodiment, the air inflow portion 17 is disposed in a left, and the air outflow portion 28 in a right half plane along the main flow direction. Further, the first front edge and a first rear edge of the housing 13 are disposed in the left, and the other front edge as well as the other rear edge are disposed in the right half plane.

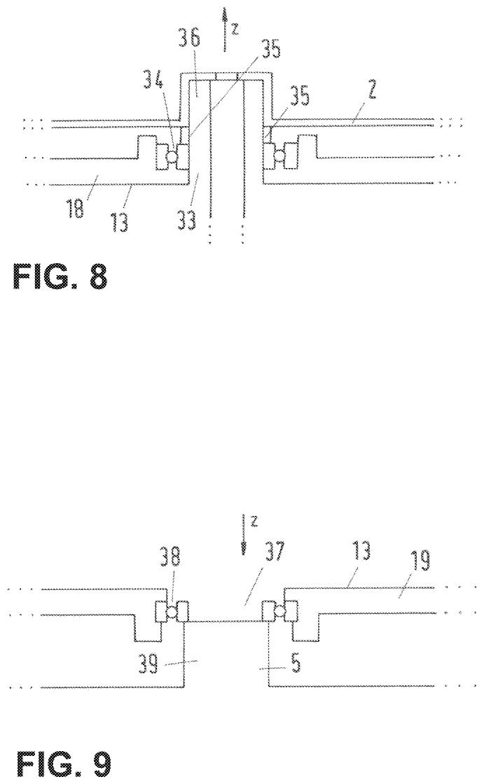

FIG. 8 shows a schematic illustration of a support of a first blade support 2 on the housing 13, particularly on the housing bottom 18. The housing bottom 18 has a through opening 33, a thickness of the housing bottom 18 being increased along the vertical axis z in the portion surrounding the through opening 33. In the through opening 33, a ball or roller bearing 34 is disposed. The first blade support 2 is supported on the rotatable part of the bearing 34 via support portions 35. Further, it is illustrated that a shaft 16 of the generator extends through the through opening 33 and through the bearing 34 and is secured on, particularly screwed to the first blade support 2 on an end facing away from the generator. Here, the first blade support 2 forms an indentation 36 for accommodating the shaft 16.

FIG. 9 shows a schematic illustration of a support of a third blade support 5 on the housing 13, particularly on the housing cover 19. The housing cover 19 has a through opening 37, a thickness of the housing cover 19 being increased along the vertical axis z in the portion surrounding the through opening 37. In the through opening 37, a ball or roller bearing 38 is disposed. The third blade support 5 is supported on the rotatable part of the bearing 38 with a cylindrical protrusion 39.

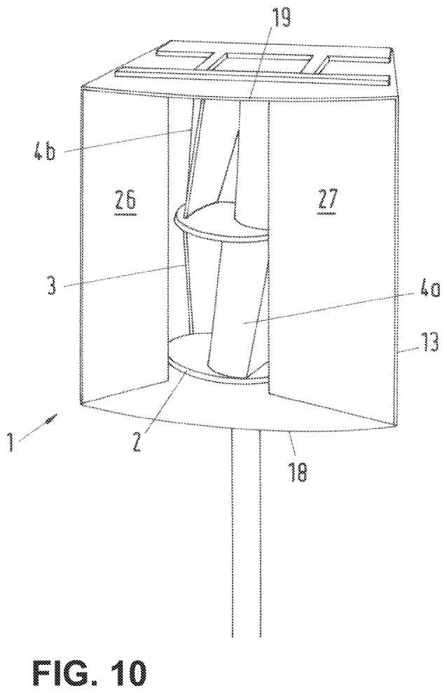

FIG. 10 shows a perspective view of the rotor 1 including the housing 13. Particularly, the first side wall 26, the second side wall 27, the housing bottom 18 and the housing roof 19 defining the air inflow portion 17 (see FIG. 7) are illustrated. Further, the helical extension/the helical progression of the rotor blades 4a, 4b between the blade supports 2, 3, 5 can be seen in FIG. 10.

It is understood that the foregoing description is that of the exemplary embodiments of the disclosure and that various changes and modifications may be made thereto without departing from the spirit and scope of the invention as defined in the appended claims.

What is claimed is:

1. A rotor for a wind power installation, the rotor comprising:
a first blade support;
a second blade support;
a first set of at least two rotor blades, wherein the at least two rotor blades of the first set have a vane-shaped configuration and extend helically from the first blade support to the second blade support;
at least one additional blade support; and
at least one additional set of at least two rotor blades,
wherein the at least two rotor blades of the at least one additional set have a vane-shaped configuration and extend helically from the second blade support to the at least one additional blade support, and
wherein an arrangement of the at least two rotor blades of the at least one additional set is arranged with an angular offset to the arrangement of the at least two rotor blades of the first set of the at least two rotor blades.

2. The rotor according to claim 1, wherein at least one of the first set of the at least two rotor blades and the at least one additional set of the at least two rotor blades includes exactly three rotor blades.

3. The rotor according to claim 1, wherein at least one of the first, second, and at least one additional blade supports and/or at least one of the first set and the at least one additional set of the at least two rotor blades is/are made of aluminum or of plastic.

4. The rotor according to claim 1, wherein a helical reference line of a rotor blade of the first set and the at least one additional set of the at least two rotor blades intersects a reference plane which is oriented perpendicular to a rotational axis of the rotor at an angle from an angle range of inclusively 64° to inclusively 84°.

5. The rotor according to claim 1, further comprising:
a housing,
wherein the first, second, and at least one additional blade supports and the first set and the at least one additional set of the at least two rotor blades are arranged in an inner volume of the housing.

6. The rotor according to claim 5, wherein the housing forms an air inflow portion, and
wherein the air inflow portion has a funnel-shaped configuration.

7. The rotor according to claim 6, wherein an opening angle of the air inflow portion is an angle from an angle range of inclusively 66° to inclusively 86°.

8. The rotor according to claim 6, wherein an angle between a first side wall and another side wall defining the air inflow portion and being oriented perpendicular to a cross-sectional plane is an angle from an angle range of inclusively 66° to inclusively 86°.

9. The rotor according to claim 6, wherein, in a cross-sectional plane oriented perpendicular to a rotational axis of the rotor, a first side wall defining the air inflow portion and oriented perpendicular to the cross-sectional plane forms at least a portion of a first leg of a trapezoid and encloses an angle from a range of inclusively 70° to inclusively 84° together with a base of the trapezoid, and
wherein another side wall defining the air inflow portion and oriented perpendicular to the cross-sectional plane forms at least a portion of another leg of the trapezoid and encloses an angle from a range of inclusively 30° to inclusively 34° together with the base of the trapezoid.

10. The rotor according to claim 5, wherein the housing forms an air outflow portion, and
wherein the air outflow portion has a funnel-shaped configuration.

11. The rotor according to claim 5, wherein a percentage of a surface area of a rear side of the housing of an entirety of the surface area of the rear side of the housing and an air outflow area is from inclusively 20% to inclusively 26% at most.

12. The rotor according to claim 5, wherein the first blade support is at least partly arranged in a recess in an area of a housing bottom, and/or
wherein the at least one additional blade support is at least partly arranged in a recess in the area of a housing cover.

13. The rotor according to claim 12, wherein the first blade support has or forms a recess for accommodating and securing a generator shaft, and/or
wherein the housing bottom has or forms a reinforced through opening for accommodating the generator shaft.

14. The rotor according to claim 5, wherein the at least one additional blade support includes or forms a bearing element for a support on a housing cover, and/or
wherein the housing cover has or forms a reinforced through opening for accommodating the bearing element.

15. A method for operating the rotor according to claim 1, the method comprising:
mechanically connecting a generator to the rotor; and
exposing the rotor to an airflow.
